(19) United States
(12) Patent Application Publication
(10) Pub. No.: US 2008/0012267 A1
(43) Pub. Date: Jan. 17, 2008

(54) Hitch accessory stabilizing device

(76) Inventor: Doug Simon, Columbia, MO (US)

Correspondence Address: BRYAN CAVE LLP, 211 NORTH BROADWAY, SUITE 3600, ST. LOUIS, MO, 63102-2750, US

(21) Appl. No.: 11/801,626

(22) Filed: May 10, 2007

Related U.S. Application Data
(60) Provisional application No. 60/799,144, filed on May 10, 2006.

(51) Int. Cl. B60D 1/00

(52) U.S. Cl. 280/504

(57) ABSTRACT

The present invention relates to methods and devices for stabilizing vehicle hitch mounted products and accessories. In certain embodiments of the invention, such devices comprise a bracket having an angled edge, an eye-bolt that removably attaches to the bracket, and a knob that secures the bracket and eye-bolt to a vehicle hitch assembly. In such embodiments, the angled edge is forced into the dimensional space that exists between the outside surface of a hitch accessory plug and a hitch receiver port, whereby the bracket serves to stabilize and reduce movement between the outside surface of the hitch accessory plug and hitch receiver port.

### CROSS-REFERENCE TO RELATED APPLICATIONS

This application claims priority to and incorporates by reference U.S. provisional patent application Ser. No. 60/799,144, filed May 10, 2006.

### FIELD OF THE INVENTION

The present invention relates to the field of methods and devices for stabilizing vehicle hitch mounted products and accessories.

### BACKGROUND OF THE INVENTION

The present invention relates to an apparatus which stabilizes vehicle hitch mounted accessories during transport and while in use. Vehicle hitch mounted products, or accessories, have become popular due to an American automotive industry standardization of tow hitch ports integral to the rear frame of the vehicle. Most domestically produced utilitarian vehicles (i.e. SUV's, pick-ups, vans) feature a square, tubular port, or hitch receiver, intended for the removable attachment of hitches for towing purposes. Common to the market are numerous vehicle-mounted products which removably attach to the vehicle via the hitch receiver. These products include, but are not limited to, bicycle racks, ski racks, pick-up bed extenders, picnic tables, work surfaces and cargo carriers.

Hitch receiver mounted accessories require a square tubular protrusion, or plug, which mate with the square port of the hitch receiver. The plug is generally rigidly attached to the accessory and is incorporated into the accessory design. Several different sizes of hitch receivers are common, but the two most popular accept hitch accessories with male protrusions 2″ square and 1 ¼″ square. Assembly of the accessory to the hitch receiver is as follows: 1) the accessory plug is telescopically inserted into the hitch receiver port, 2) holes located in the vertical surfaces normal to the central axes of the plug and port are coaxially aligned, 3) a round, steel pin is removably inserted into the coaxially aligned holes. Axial translation between the plug and hitch receiver is prevented by the steel pin and rotational movement relative to the plug and receiver is constrained by their mating square cross sections. To accept a nominally sized hitch accessory, the hitch receiver must have a port greater in cross sectional area than the accessory plug. This dimensional allowance between the plug and hitch receiver is necessary so the plug may be inserted and removed easily. A 2″ hitch receiver port may actually have a width and height of 2.04″×2.04″. The dimensional allowance that allows easy assembly also allows the plug to translate laterally and rotate by small fractions of an inch within the hitch receiver. This small amount of movement may seem inconsequential while the vehicle is stationary, but can transform into an audible rattle and significant sway of the accessory when the vehicle is moving and subjected to normal vibrations from a road surface. Many accessory plugs extend beyond the end of the hitch receiver by 12-18″. The small amount of movement at the hitch receiver port is amplified by the plug length, therefore allowing greater movement at the end of the accessory opposite the hitch receiver.

Patents to Breslin (U.S. Pat. No. 5,593,172) and to Stein (U.S. Pat. No. 6,010,143) both present stabilizing, or anti-rattle, devices for towing and hitch receiver mounted accessories. Breslin relates to a device that utilizes a bracket with multiple set screws to reduce the dimensional allowance, or play, between the plug and hitch receiver. Stein describes an apparatus that removably attaches to the accessory plug that applies a downward vertical force to the plug relative to the hitch receiver port. The apparatus mounts below the bottom surfaces of the plug and hitch receiver, thus decreasing the distance between the road level and any attachments to the vehicle.

### SUMMARY OF THE INVENTION

The present invention relates to an apparatus which helps stabilize vehicle hitch mounted accessories during transport and while in use. It is an object of this invention to provide a device that is easily removable from the hitch receiver and hitch mounted accessory. It is a second object of the invention to provide a device that fits all sizes of hitch receivers; this includes, but is not limited to, 1 ¼″ and 2″ hitch receivers.

The stabilizing device utilizes a wedging action between the inside surface of the hitch receiver port and the outside surface of the hitch accessory plug. The device consists of a bracket with an angled edge that is removably attached to an eye-bolt. The eye of the bolt is removably attached to the hitch pin during assembly of the hitch accessory to the hitch receiver. The angled edge of the bracket is inserted in the gap created by the normal dimensional allowance between the hitch receiver port and accessory plug. A knob threadably attached to the eye-bolt and resting against the rear surface of the bracket is rotated clockwise to tighten the bracket relative to the transversely retained bolt eye. This forces the angled edge of the bracket between the inside surface of the hitch receiver port and the outside surface of the hitch accessory plug. The wedging action of the angled edge forces the two parts away from each other and eliminates the dimensional allowance, or play. With the dimensional allowance eliminated the two parts are restricted from moving relative to each other, therefore stabilizing the hitch accessory.

### BRIEF DESCRIPTION OF THE DRAWINGS

FIG. 1 is an exploded left side perspective view of a vehicle hitch receiver and cargo carrier.

FIG. 2 is a detail view of a portion of FIG. 1.

FIG. 3 is an assembled view of FIG. 1.

FIG. 4 is a left side perspective of the stabilizing device.

FIG. 5 is an exploded view of FIG. 4.

FIG. 6 is an exploded detail view of the vehicle hitch receiver, cargo carrier and stabilizing device.

FIG. 7 is an assembled view of FIG. 6 with the stabilizing device not tightened.

FIG. 8 is a subsequent view to FIG. 7 with the stabilizing device tightened.

FIG. 9 is a rear elevation view of the hitch receiver.

FIG. 10 is a detailed view of a portion of FIG. 9 with the stabilizing device not tightened.

FIG. 11 a subsequent view to FIG. 10 with the stabilizing device tightened.

### DETAILED DESCRIPTION OF THE INVENTION

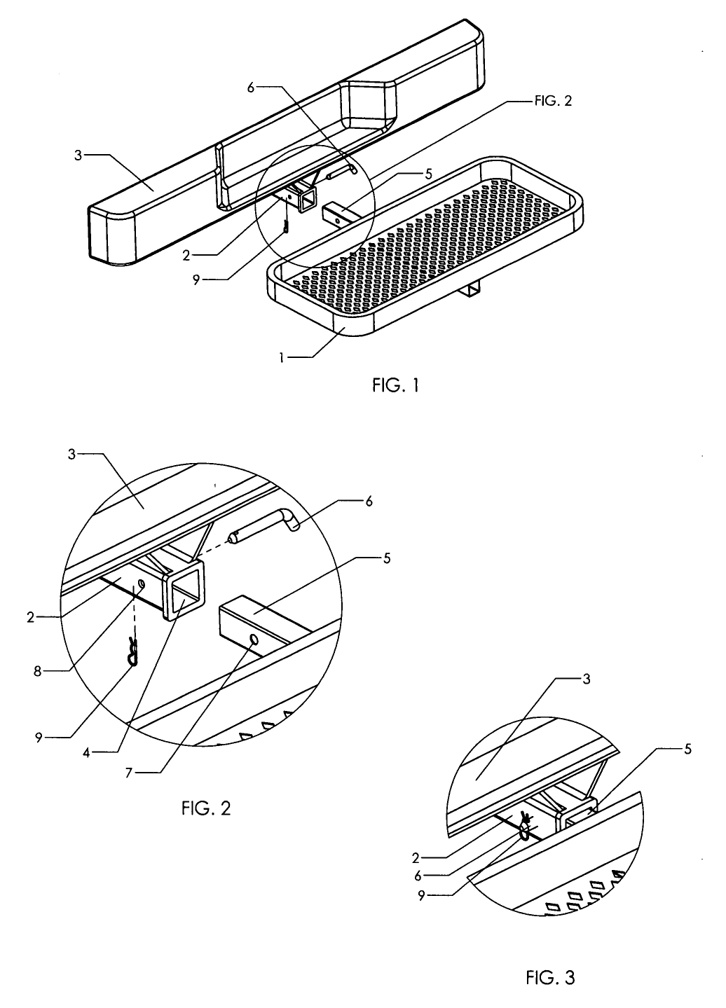

The present invention provides a hitch accessory stabilizing device which stabilizes vehicle hitch mounted accessories during transport and while in use (e.g. cargo carriers, tow bars, tailgate tables, bike racks, or other accessories). An exemplary accessory that may be utilized with the stabilizing device is a cargo carrier. A typical hitch receiver-mounted cargo carrier 1, as shown in FIGS. 1-3, is removably attachable to the hitch receiver 2, which is generally integral to the vehicle frame and protrudes below the rear bumper 3. The hitch receiver 2 is of a square, tubular shape with a nominally size square opening 4. The cargo carrier 1, as do all hitch receiver-mounted accessories, has a square, tubular “plug” 5 that telescopically mates with the hitch receiver 2. A hitch pin 6, fabricated of steel round stock, is used to attach the cargo carrier 1 to the hitch receiver 2. A nominally sized round through hole 7 perpendicular to the side surface of the cargo carrier male protrusion, or plug 5, is aligned with a similarly sized round through hole 8 in the side surface of the hitch receiver 2. The hitch pin 6 is inserted through both holes 7, 8. The hitch pin 6 is transversely secured by a bridge pin 9 inserted into a through hole perpendicular to the outer surface of the hitch pin 6.

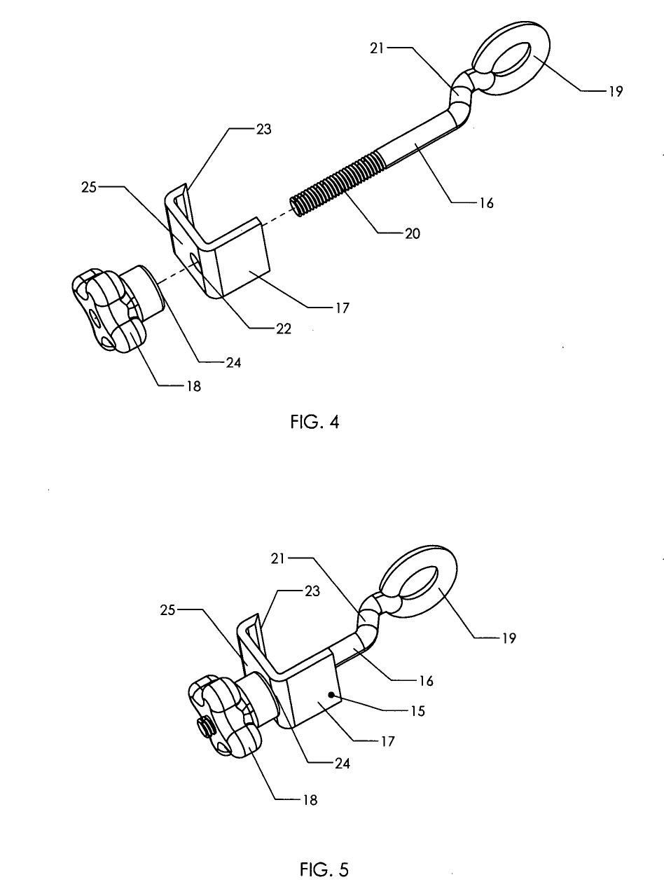

As shown in FIGS. 4-5, one embodiment of the stabilizing device, generally indicated 15, comprises three parts, namely, an eye bolt 16, a wedge bracket 17 and a threaded knob 18. The eye bolt 16 is fabricated of steel round stock with a circular loop 19, or eye, at one end and a male thread pattern 20 on the opposite end. Below the eye 19 an axial offset 21 of approximately ½″ is formed in the eye bolt 16. The wedge bracket 17 slidably engages the eye bolt 16 via a through hole 22. The wedge bracket 17 is generally of a “J” shape with the inside edge 23 of the shorter side ground at an angle. The knob 18 is threadably engaged to the eye bolt 16 with the bottom surface of the cylindrical hub 24 contacting the top surface 25 of the wedge bracket 17.

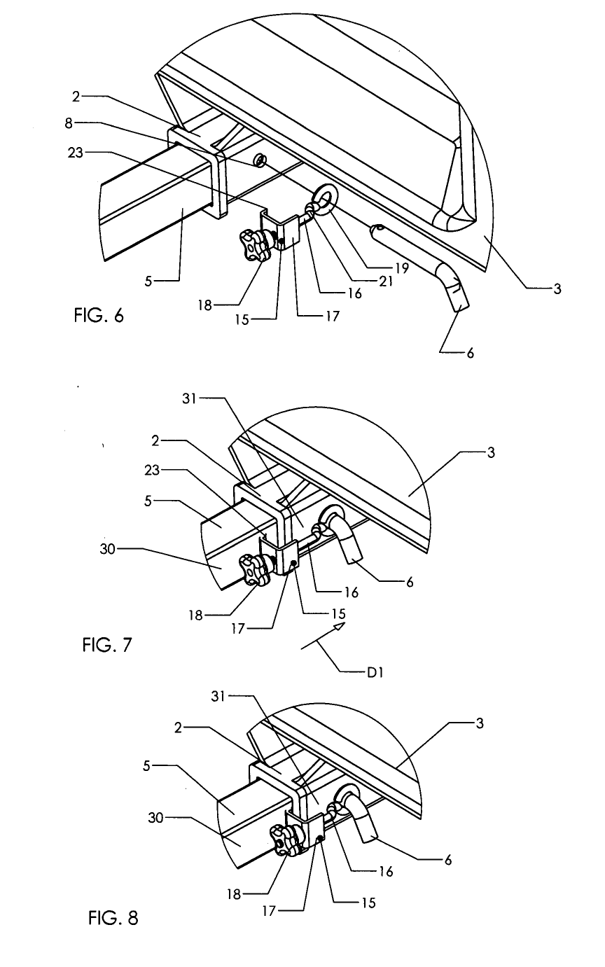

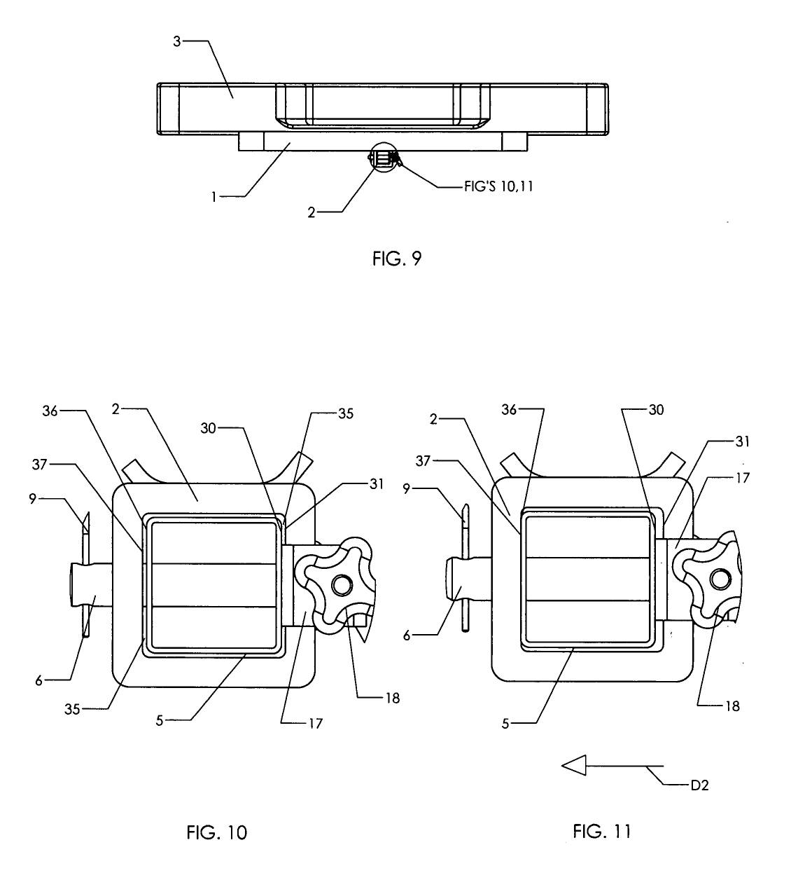

FIGS. 6-8 illustrate the removable attachment of the stabilizing device 15 to the hitch receiver 2. The hitch pin 6, which retains the cargo carrier 1 to the hitch receiver 2 as illustrated in FIGS. 1-3, is axially inserted through the eye 19 of the eye bolt 16 (see FIG. 6). The stabilizing device 15 is oriented in such a manner that the direction of the offset 21 of the eye bolt 16 is away from the hitch receiver. Offset 21 eliminates interference between the knob 18 and plug 5 when the stabilizing device is attached to the hitch receiver 2. The hitch pin 6 is then axially inserted into the aligned holes 7, 8 of the cargo carrier plug 5 and the hitch receiver 2. With the angled edge 23 of the wedge bracket 17 parallel to the right, outside vertical surface 30 of the plug 5, the knob 18 is rotated clockwise about the male threads 20 of the eye bolt 16 (see FIG. 7). The bottom surface 24 of the knob 18 contacts the top surface 25 of the wedge bracket 17 generating an axial translation in the direction indicated D1 of the knob wedge bracket 17. The axial translation of the wedge bracket 17 and knob 18 in the direction D1 forces the angled edge 23 between the outer, right vertical surface 30 of the plug and the inner, right vertical surface of the hitch receiver 31 (see FIG. 8). The angled edge 23 acts as a wedge between the right vertical surfaces 30 and 31 forcing them away from each other in a horizontal direction.

FIGS. 10-11 illustrate the stabilizing device 15 eliminating the dimensional allowance 35, or open space, between the plug 5 and hitch receiver 2. FIG. 10 shows the plug 5 centered in the port 4 of the hitch receiver 2 with common dimensional allowance 35 between the two parts. As the angled edge 23 is inserted between the right vertical surfaces 30 and 31 the wedge bracket 17 forces the plug 5 to translate in a horizontal direction D2 away from the wedge bracket 17 and right vertical surface 31. The knob 18 is rotated clockwise until the axial translation of the wedge bracket 17 causes the outer, left vertical surface 36 of the plug 5 to contact the inner, left vertical surface 37 of the hitch receiver (see FIG. 11). The dimensional allowance 35 is now eliminated between the right vertical surfaces 30 and 31 and the left vertical surfaces 36 and 37. This eliminates undesirable lateral movement, and therefore rotational movement, between the plug 5 and hitch receiver 2.

What is claimed is:

1. A device for stabilizing vehicle hitch receiver accessories by reducing dimensional allowance between an inside surface of a hitch receiver and an outside surface of a hitch receiver accessory plug, wherein the device comprises:
(a) a threaded member having an opening at one end thereof,
(b) a bracket having an opening through which the threaded member is inserted; and
(c) a knob that threadably secures the bracket to the threaded member, wherein an edge of the bracket is disposed between an inside surface of a hitch receiver and an outside surface of a hitch receiver accessory plug.

2. The device of claim 1, wherein the edge of the bracket is angled, wherein the angled edge is disposed between the inside surface of the hitch receiver and the outside surface of the hitch receiver accessory plug.

3. The device of claim 1, wherein a hitch pin is disposed within the opening of the threaded member.

4. The device of claim 1, wherein the threaded member is an eye bolt.

5. The device of claim 4, wherein a hitch pin is disposed within an eye portion of the eye bolt.

6. The device of claim 1, wherein the bracket is so dimensioned to be capable of being disposed between the inside surfaces of hitch receivers and the outside surfaces of hitch receiver accessory plugs of variable sizes.

7. The device of claim 1, wherein the bracket is so dimensioned to be capable of being disposed between the inside surface of a hitch receiver and the outside surface of a hitch receiver accessory plug, wherein said plug is a square tubular protrusion having approximately 2 inch sides.

8. The device of claim 1, wherein the bracket is so dimensioned to be capable of being disposed between the inside surface of a hitch receiver and the outside surface of a hitch receiver accessory plug, wherein said plug is a square tubular protrusion having approximately 1.25 inch sides.

9. The device of claim 1, wherein rotating the knob (a) secures the bracket to the threaded member, (b) forces the inside surface of the hitch receiver to contact the outside surface of the hitch receiver accessory plug, and (c) reduces the dimensional allowance between the inside surface of the hitch receiver and the outside surface of the hitch receiver accessory plug.

10. A method for stabilizing vehicle hitch receiver accessories by reducing dimensional allowance between an inside surface of a hitch receiver and an outside surface of a hitch receiver accessory plug, wherein the method comprises:
(a) inserting a threaded member, which comprises a first end having an opening therein, into a through hole located in a bracket;
(b) reversibly and threadably attaching a knob to a second end of the threaded member, wherein the knob secures the bracket to the threaded member; and
(c) disposing an edge of the bracket between an inside surface of a hitch receiver and an outside surface of a hitch receiver accessory plug.

11. The method of claim 10, wherein the edge of the bracket is angled, wherein the angled edge is disposed between the inside surface of the hitch receiver and the outside surface of the hitch receiver accessory plug.

12. The method of claim 10, wherein a hitch pin is disposed within the opening of the threaded member.

13. The method of claim 10, wherein the threaded member is an eye bolt.

14. The method of claim 13, wherein a hitch pin is disposed within an eye portion of the eye bolt.

15. The method of claim 10, wherein the bracket is so dimensioned to be capable of being disposed between the inside surfaces of hitch receivers and the outside surfaces of hitch receiver accessory plugs of variable sizes.

16. The method of claim 10, wherein the bracket is so dimensioned to be capable of being disposed between the inside surface of a hitch receiver and the outside surface of a hitch receiver accessory plug, wherein said plug is a square tubular protrusion having approximately 2 inch sides.

17. The method of claim 10, wherein the bracket is so dimensioned to be capable of being disposed between the inside surface of a hitch receiver and the outside surface of a hitch receiver accessory plug, wherein said plug is a square tubular protrusion having approximately 1.25 inch sides.

18. The method of claim 10, wherein rotating the knob (a) secures the bracket to the threaded member, (b) forces the inside surface of the hitch receiver to contact the outside surface of the hitch receiver accessory plug, and (c) reduces the dimensional allowance between the inside surface of the hitch receiver and the outside surface of the hitch receiver accessory plug.
